(19) United States
(12) Patent Application Publication
(10) Pub. No.: US 2007/0221256 A1
(43) Pub. Date: Sep. 27, 2007

(54) Methods and apparatus for improving edge cleaning of a substrate

(76) Inventors: Hui Chen, (US); Anne-Douce M.P. Coulin, (US); Ho Seon Shin, (US); Donald J.K. Olgado, (US)

Correspondence Address: DUGAN & DUGAN, PC, 55 SOUTH BROADWAY, TARRYTOWN, NY, 10591, US

(21) Appl. No.: 11/389,528

(22) Filed: Mar. 24, 2006

(51) Int. Cl. B08B 7/00; B08B 3/00

(52) U.S. Cl. 134/33; 134/149; 134/151; 134/153; 134/34

(57) ABSTRACT

In a first aspect, an apparatus is provided that includes (1) an idler adapted to contact a substrate, to rotate therewith, and to sense rotation of the substrate; and (2) a driving mechanism coupled to the idler and adapted to drive the idler. Numerous other aspects are provided.

### FIELD OF THE INVENTION

The present invention relates generally to semiconductor device manufacturing and more particularly to methods and apparatus for improving edge cleaning of a substrate.

### BACKGROUND OF THE INVENTION

Conventional semiconductor device manufacturing may employ a polishing process such as chemical mechanical polishing (CMP) to polish the surface of a substrate. Conventional polishing processes employ slurry or another suitable fluid as a polishing agent.

A residue of undesirable material, such as slurry and substrate particles, may be left on a substrate by the polishing process. Accordingly, a substrate must be cleaned after polishing. Conventional cleaning processes include scrubbing with a brush or employing a megasonically energized cleaning fluid to remove slurry and/or substrate residue from a substrate. However, the edge of the substrate is conventionally a problem area for cleaning and may not be free of slurry and/or substrate particles following cleaning. Therefore, methods and apparatus that improve edge cleaning are needed.

### SUMMARY OF THE INVENTION

In a first aspect of the invention, a first apparatus is provided that includes (1) an idler adapted to contact a substrate, to rotate therewith, and to sense rotation of the substrate; and (2) a driving mechanism coupled to the idler and adapted to drive the idler.

In a second aspect of the invention, a second apparatus is provided that includes (1) an idler adapted to contact a substrate, to rotate therewith, and to sense rotation of the substrate; and (2) a dedicated cleaning mechanism adapted to clean the idler.

In a third aspect of the invention, a first method is provided that includes the steps of (1) providing an idler adapted to contact a substrate, to rotate therewith, and to sense rotation of the substrate; and (2) applying a driving force, other than a force applied by a rotating substrate, to the idler, so as to drive rotation of the idler when the idler is not in contact with the substrate.

In a fourth aspect of the invention, a second method is provided that includes the steps of (1) providing an idler adapted to contact a substrate, to rotate therewith and to sense rotation; and (2) cleaning the idler with a cleaning mechanism dedicated to cleaning the idler.

Other features and aspects of the present invention will become more fully apparent from the following detailed description, the appended claims and the accompanying drawings.

### BRIEF DESCRIPTION OF THE DRAWINGS

FIG. 1 is a schematic front view depicting a conventional cleaning apparatus with driving rollers which rotate a substrate which in turn rotates an idler.

FIG. 2 is a schematic front view depicting a first embodiment of an inventive substrate cleaner having a driving mechanism coupled to an idler so as to rotate the idler

FIG. 3 is a schematic front view depicting a second embodiment of an inventive substrate cleaner having a dedicated cleaning mechanism for cleaning an idler in accordance with an embodiment of the present invention.

FIG. 4 is a schematic front view depicting a preferred embodiment of an inventive cleaner wherein a fluid spray is directed to an idler to clean the idler.

FIG. 5 is a side view of the inventive idler of FIG. 4.

FIG. 6 is a front perspective view of an exemplary embodiment of a spray bar that may be used to spray, clean and/or rotate the idler of FIG. 4.

### DETAILED DESCRIPTION OF THE DRAWINGS

The present invention provides methods and apparatus for cleaning an idler used during substrate cleaning (e.g., a roller that rotates with a substrate, but that does not affect the rotation speed of the substrate). During a substrate cleaning process, a substrate is typically rotated by motorized rollers or other suitable apparatus so that the entire surface of the substrate rotates past a cleaning mechanism (e.g., a scrubbing brush, a spray nozzle, a transducer, etc.). The substrate rotation may be monitored by an idler.

A conventional idler contacts the substrate and rolls passively therewith so as to match the rotation of the substrate. When the idler no longer contacts the substrate, the idler stops rotating. Since conventional idlers are not actively driven (e.g. by a motor), such idlers do not rotate during non-processing times. Some undesirable material, such as slurry and/or substrate residue, may remain on the idler as a result of the idler not rotating. During a subsequent cleaning step, a substrate contacts the idler and may contact the undesirable material on the idler. The undesirable material may affect the surface of the substrate (e.g., etching away a portion of the substrate, depositing a particle or film on the substrate, etc.), thereby forming undesirable features referred to as edge signatures.

The present invention provides, in a first embodiment, a driving mechanism for driving an idler to rotate so that the idler may be rotated even when not in contact with a substrate. As such, undesirable material may be rinsed from the idler as it rotates. The idler may be rotated even during non-processing times and the buildup of undesirable material that may otherwise form may be reduced and/or prevented. In a second embodiment a dedicated cleaning mechanism is employed to clean the idler. In a third embodiment the idler employs a fluid spray to both drive rotation of the idler, and to clean the idler. Preferably, the idler may have features along its surface that facilitate driving of the idler via the fluid spray.

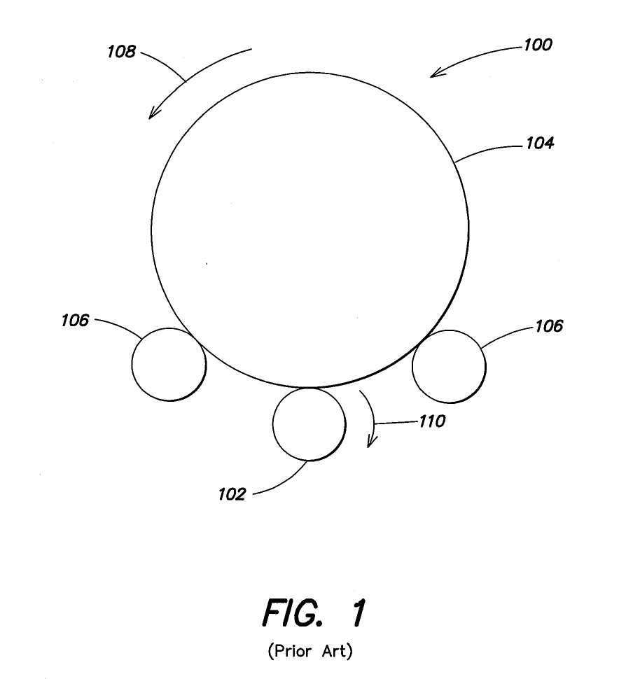

FIG. 1 is a schematic front view depicting a conventional cleaning apparatus 100 with driving rollers which rotate (or “drive”) a substrate which in turn rotates (drives) an idler. In the conventional cleaning apparatus 100, an idler 102 may be in contact with a substrate 104. Drive rollers 106 may also be in contact with the substrate 104. The drive rollers 106 may rotate under the influence of one or more motors (not shown) so as to rotate the substrate 104 in any suitable direction, such as in the direction depicted by an arrow 108. Also, because the idler 102 is in contact with the substrate 104, the substrate 104 may impart rotation to the idler 102. By monitoring the rotation of the idler 102, the rotation of the substrate 104 may be determined. However, as discussed above, such a passive idler may collect slurry residue and/or other particles that may contaminate the substrate 104.

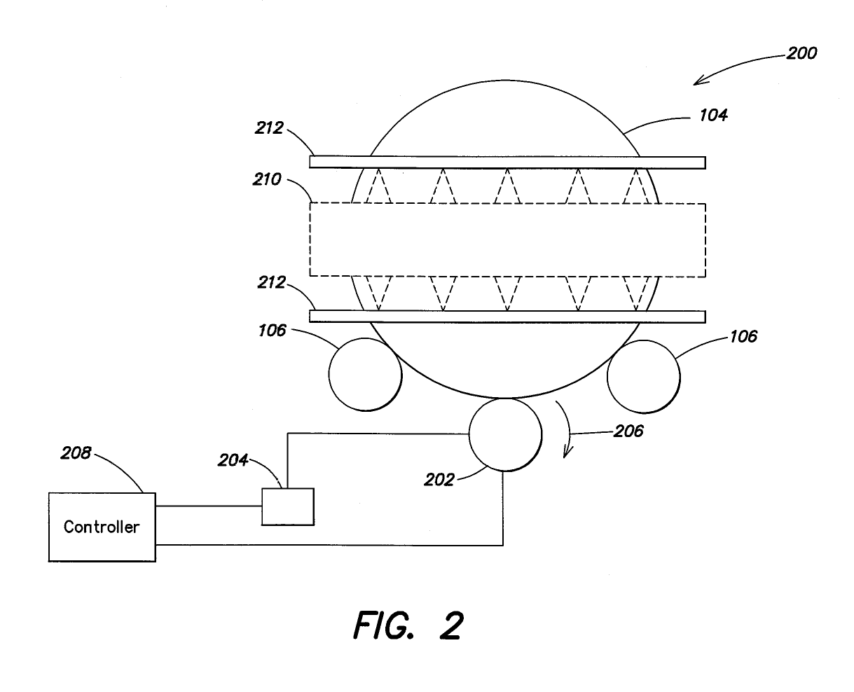

FIG. 2 is a schematic front view depicting a first embodiment of an inventive substrate cleaner 200 having a driving mechanism coupled to an idler so as to rotate the idler. With reference to FIG. 2, a driven idler 202 may be coupled to a driving mechanism 204 (e.g., a motor, a fluid spray, or another suitable drive mechanism). The driven idler 202 may be disposed in the inventive substrate cleaner 200 so as to contact a substrate 104. As in the conventional cleaning system 100, drive rollers 106 may be present in the inventive substrate cleaner 200 and disposed so as to be in contact with the substrate 104. Note that other idler and/or drive roller locations and/or numbers may be employed. For example, the idler 202 need not be located between the drive rollers 106.

As stated, the driving mechanism 204 may couple to the driven idler 202 so as to rotate the driven idler 202. A rotation of the driven idler 202 depicted by the arrow 208 may assist in the removal of undesirable material from the driven idler 202. In addition to imparting a rotation on the driven idler 202, the driving mechanism 204 may impart a force (e.g., centripetal) directly onto the undesirable material so as to motivate the undesirable material from the driven idler 202. In addition, the driven idler 202 may provide a signal indicative of idler and/or substrate rotation rate. For example, the idler 202 may include a rotation sensor (not shown) that monitors rotation rate of the idler 202 and/or provides rotation information to a controller 208. Based on the information provided by the idler 202, the controller 208 may determine substrate rotation rate. The controller 208 may be, for example, a microprocessor or microcontroller, or any suitable software, hardware or combination thereof.

In a preferred embodiment, the inventive substrate cleaner 200 may be a scrubber, having a scrubber brush 210 (shown in phantom) and a fluid delivery mechanism for supplying fluid to the scrubber brush 208 and/or the substrate 206. The fluid delivery mechanism may comprise one or more appropriately positioned spray nozzles, one or more sources of a fluid drip, or one or more spray bars 212 having a plurality of openings or nozzles for spraying or dripping fluid along the length of the scrubber brush 210 and/or along the diameter of the substrate 104.

Preferably, during non-processing times, the driving mechanism 204 may continue to rotate the driven idler 202 while the fluid delivery mechanism continues to supply fluid. As the driven idler 202 is rotated, undesirable material may be rinsed from the driven idler 202 via the fluid supplied from the fluid delivery mechanism. Thus, the driven idler 202 is preferably positioned such that fluid from the fluid delivery mechanism contacts the driven idler 202. For example, fluid from the spray bars 212 may drip or be sprayed on the idler 202. In at least one embodiment, the inventive substrate cleaner 200 comprises a vertically oriented double-sided scrubber (e.g., a scrubber that supports the substrate 104 in a vertical orientation and has a pair of scrubber brushes 210, one positioned along the front surface and one positioned along the back surface of the substrate 104).

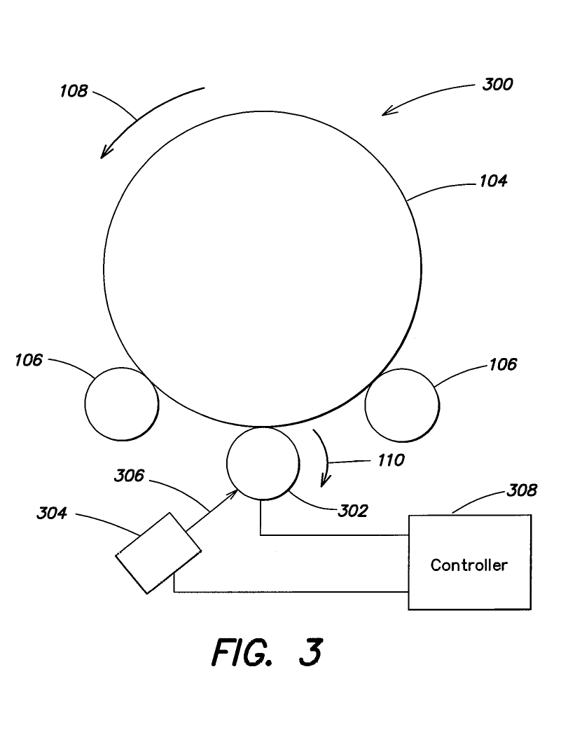

FIG. 3 is a schematic front view depicting a second embodiment of an inventive substrate cleaner 300 having a dedicated cleaning mechanism for cleaning an idler 302 in accordance with an embodiment of the present invention. As with the first cleaner 200 of FIG. 2, the substrate 104 may be in contact with the motorized rollers 106. In addition, the substrate 104 may be in contact with the idler 302.

As shown in FIG. 3, a dedicated cleaning mechanism 304 is positioned so as to clean the idler 302. The dedicated cleaning mechanism 304 may be a fluid delivery mechanism, such as a spray nozzle that provides a fluid spray 306 to the idler 302, or may be a brush and/or another suitable mechanism that cleans the idler 302. The cleaning mechanism 304 also may impart rotational motion to the idler 302 and/or otherwise serve as a driving mechanism for the idler 302.

The substrate 104 may be rotated by the motorized rollers 106, such as in the direction depicted by an arrow 108. Due to the idler 302 being in contact with the substrate 104, the idler 302 rotates in the direction depicted by the arrow 110. The fluid spray 306 may also impart a force to the idler 302. However, the force imparted to the idler 302 by the fluid spray 306 preferably is insufficient to impart a rotation to the substrate 104. The force, which may be in different directions and/or distributed, may be employed to dislodge or otherwise clean undesirable material from the idler 304. When the cleaning mechanism 304 provides a fluid spray 306 to the idler 302, the fluid spray 306 may be sonicated (e.g., megasonically energized), pulsed, continuous, periodic or the like. The cleaning mechanism 304 may be used at any time (e.g., when the substrate 104 is present or not present, during processing, only when a substrate is not being processed, etc.).

A controller 308 may be coupled to and/or control operation of the cleaning mechanism 304 and/or may be coupled to and/or monitor rotation of the idler roller 302 (and thus of the substrate 104).

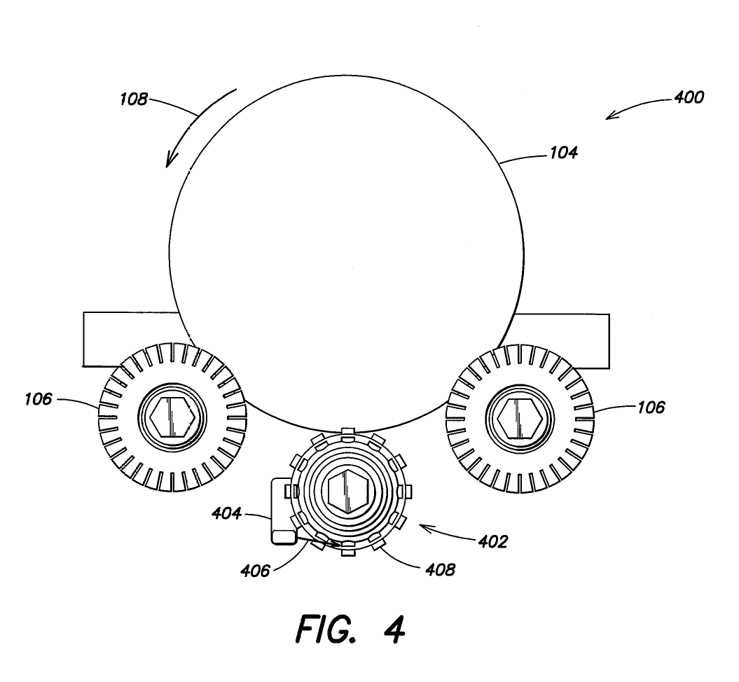

FIG. 4 is a schematic front view depicting a preferred embodiment of an inventive cleaner 400 wherein a fluid spray is directed to an idler 402 to clean the idler 402 and wherein the idler 402 has surface features to which the fluid spray is directed so as to drive rotation of the idler 402. Such an idler is referred to herein as a “surface feature idler.” As shown, the surface feature idler 402 may be in contact with the substrate 104. Further, a nozzle 404 or other fluid source may have a fluid spray 406 directed to the surface feature idler 402 so as to drive rotation thereof. For example, the nozzle 404 may be adapted to spray a stream of fluid that applies enough force to the idler 402 so as to (1) rotate the idler 402 when the idler 402 is not in contact with the substrate 104, and/or (2) not change the rate of rotation of the idler 402 when the idler 402 is in contact with the substrate 104.

As described in reference to FIG. 1, the substrate 104 may be rotated by the motorized rollers 106 in any suitable direction, such as in the direction depicted by the arrow 108. The substrate 104 may impart a rotation on the surface feature idler 402.

The fluid spray 406 may include water, cleaning solution, gas, any combination thereof and/or any other suitable fluid that may remove undesirable material from the surface feature idler 402. The fluid spray 406 may be sonicated, pulsed, continuous, periodic or the like, and may be employed at any time (e.g., when the substrate 104 is present or not present, during processing, only when a substrate is not being processed, etc.).

Still referring to FIG. 4, the surface feature idler 402 may have surface features 408 (e.g., cutouts, tabs, grooves, surface roughening or other features formed on the idler) that traverse at least a portion of a surface of the idler 402. Such features may enhance and/or allow removal of undesirable material from the surface feature idler 402 by receiving a portion of the fluid spray 406 and inducing rotation of the surface feature idler 402.

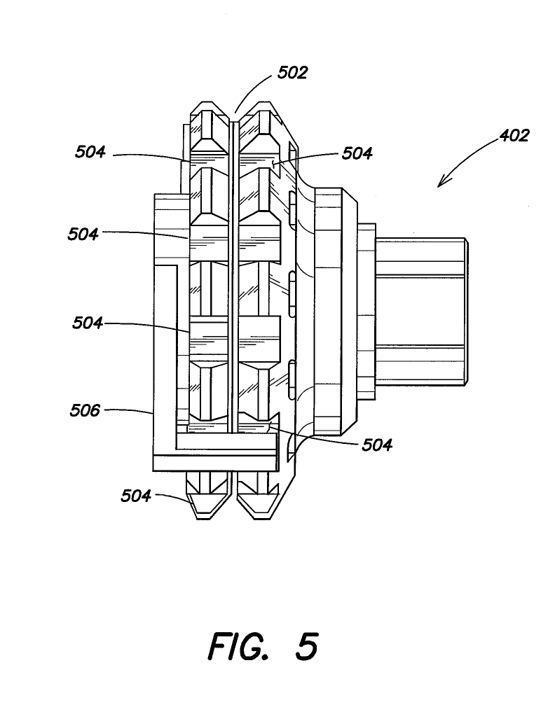

FIG. 5 is a side view of the inventive idler 402. As shown in FIG. 5, the idler 402 includes a groove 502 for receiving and supporting the substrate 104. In the embodiment of FIG. 5, the idler 402 includes a plurality of cut-out regions 504 that extend across a width of the idler 402. Other cut-out region shapes and/or sizes may be used. For example, in some embodiments, the cut-out regions 504 may only extend across a portion of the idler 402, fewer or more cut-out regions may be used and/or different cut-out regions spacings may be employed. Note that the cut-out regions also serve to drain fluid away from the idler 402 (e.g., at the idler-substrate interface).

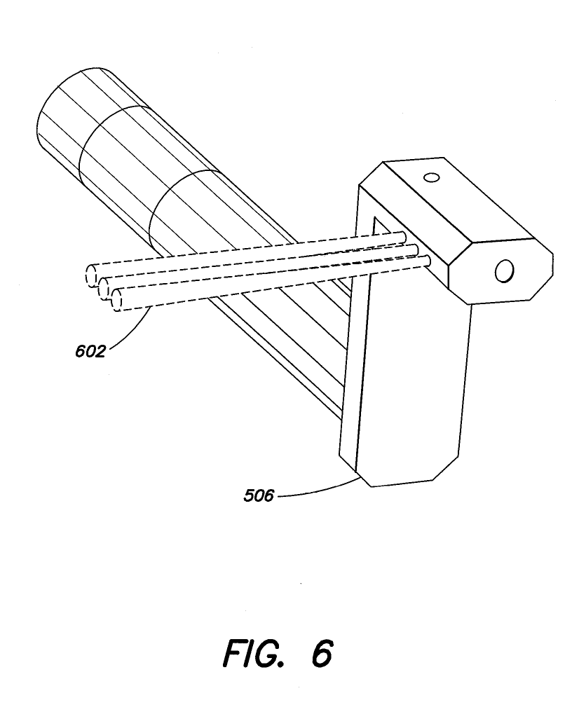

As shown in FIG. 5, a spray bar or nozzle 506 is positioned near a bottom of the idler 402 (although other positions may be used). The spray bar 506 may provide a spray pattern that is directed at the idler 402. For example, FIG. 6 is a front perspective view of an exemplary embodiment of the spray bar 506 that produces an effectively flat spray pattern 602 that may be used to spray, clean and/or rotate the idler 402 by directing fluid at the cut-out regions 504. The spray bar or nozzle may be separate from or coupled to the idler 402. For example, a mounting plate or similar jig (not shown) may couple to the idler 402 and provide a mounting location for the spray bar or nozzle.

Each of the embodiments of the inventive substrate cleaners of FIGS. 2-4 preferably operates so as to rotate the inventive idler during non-processing times (e.g., the idler is driven via either a motor or via a fluid spray). In at least one embodiment, the same fluid source (e.g., a DIW, cleaning solution or other fluid source) used to clean and/or rinse a substrate during processing times may be used during non-processing times to provide fluid to and clean the inventive idler. Additionally or alternatively, a separate fluid source (e.g., a DIW, cleaning solution or other fluid source) may provide fluid to and clean the inventive idler.

A fluid delivery mechanism, such as a nozzle, spray bar or the like used to deliver fluid to clean and/or rinse a substrate during processing times may be used during non-processing times to provide fluid to and clean the inventive idler. Alternatively, or additionally, a dedicated fluid spray from a nozzle, spray bar or other fluid delivery mechanism may be employed to clean and/or rotate the inventive idler. Because the inventive idler is actively driven (e.g., not driven only via rotation of the substrate) and may rotate during non-processing times, particles and other undesirable material may be rinsed from the entire contact surface of the idler, and contamination of subsequently processed substrates may be reduced.

Although rotation during non-processing times is preferred, the inventive idlers 302 and 402 of FIGS. 3 and 4, respectively, may be cleaned sufficiently via the idler cleaner 306 or the fluid spray 406, such that additional rotation and cleaning during non-processing times is not needed. When the idler cleaner 306 and the fluid spray 406 of FIGS. 3 and 4, respectively, apply a force to the idlers 302 and 402 during processing times, the inventive substrate cleaners 300 and 400 may be configured such that the forces applied by the cleaning mechanism 304 and fluid spray 406 are insufficient to affect rotation of the substrate 104 being cleaned.

In each of the embodiments of FIGS. 2-4, the inventive idler includes any conventional mechanism for sensing rotation of a substrate (e.g., magnetic sensing, optical sensing, etc.). Each of the inventive cleaners of FIGS. 2-4 may include a controller, coupled to the idler driving mechanism and configured to control the driving mechanism so as to drive rotation of the idler during non-processing times. For the embodiments of FIGS. 3 and 4, the controller may also be configured to control the cleaning mechanism 304 and the fluid spray 406 so as to apply a force to the idler that is not sufficient to affect rotation of the substrate 104.

The foregoing description discloses only exemplary embodiments of the invention. Modifications of the above disclosed apparatus and methods which fall within the scope of the invention will be readily apparent to those of ordinary skill in the art. For instance, the inventive cleaning apparatuses of FIGS. 2-4 preferably comprise double-sided scrubbers adapted to support vertically oriented substrates, for example, in a brush box or other processing location. Scrubbers having other orientations, more or less or other types of scrubber brushes (e.g., roller brushes, pancake brushes, etc.) may employ the inventive idler. Additionally, other types of substrate cleaners may employ the inventive idler. For example, sonic cleaners that employ sonic spray nozzles, or that submerge a substrate in a tank of sonicated fluid, may employ the inventive idler. Also, cleaners that spin, rinse and/or dry a substrate (e.g. via Marangoni drying or via centripetal forces) may also employ the inventive idler.

Accordingly, while the present invention has been disclosed in connection with exemplary embodiments thereof, it should be understood that other embodiments may fall within the spirit and scope of the invention, as defined by the following claims.

The invention claimed is:

1. An apparatus, comprising:
an idler adapted to contact a substrate, to rotate therewith, and to sense rotation of the substrate; and
a driving mechanism coupled to the idler and adapted to drive the idler.

2. The apparatus of claim 1, wherein the driving mechanism is a nozzle adapted to spray a stream of fluid, wherein the stream of fluid applies enough force to the idler to:
rotate the idler when the idler is not in contact with the substrate, and;
not change the rate of rotation of the idler when the idler is in contact with the substrate.

3. The apparatus of claim 1, wherein the idler is further adapted to provide rotation information.

4. An apparatus, comprising:
an idler adapted to contact a substrate, to rotate therewith, and to sense rotation of the substrate; and
a dedicated cleaning mechanism adapted to clean the idler.

5. The apparatus of claim 4, wherein the cleaning mechanism is adapted to apply a rotational force to the idler.

6. The apparatus of claim 4, wherein the idler is adapted to provide a signal indicative of rotation.

7. The apparatus of claim 4, wherein the cleaning mechanism is a nozzle adapted to spray a fluid at the idler.

8. The apparatus of claim 7, wherein the idler has surface features that are adapted to receive the fluid so that a rotational force is applied to the idler.

9. The apparatus of claim 8, wherein the surface features are adapted to drain fluid away from the idler.

10. The apparatus of claim 8, wherein the surface features extend across a width of the idler.

11. The apparatus of claim 4, wherein the cleaning mechanism is a nozzle adapted to spray a stream of fluid, wherein the stream of fluid applies enough force to the idler to:
rotate the idler when the idler is not in contact with the substrate, and;
not change the rate of rotation of the idler when the idler is in contact with the substrate.

12. A method comprising:
providing an idler adapted to contact a substrate, to rotate therewith, and to sense rotation of the substrate; and
applying a driving force, other than a force applied by a rotating substrate, to the idler, so as to drive rotation of the idler when the idler is not in contact with the substrate.

13. The method of claim 12 wherein applying the driving force comprises applying a force to the idler so as to rotate the idler when the idler is not in contact with the substrate and so as not to affect the rate of rotation of the substrate when the idler is in contact with the substrate.

14. The method of claim 12, wherein the driving force is applied to the idler when a substrate is not contacting the idler, and further comprising supplying a fluid to the idler so as to rinse the idler while the idler rotates.

15. The method of claim 11 wherein the driving force is applied via a fluid spray.

16. The method of claim 15 wherein the driving force is applied via a fluid spray applied when the idler is not in contact with a substrate.

17. The method of claim 15 wherein the driving force is applied via a fluid spray applied when the idler is in contact with a substrate.

18. The method of clam 12 wherein providing an idler further comprises providing an idler having surface features adapted to facilitate rotation of the idler and wherein applying the driving force comprises spraying fluid on to the surface features.

19. A method comprising:
providing an idler adapted to contact a substrate, to rotate therewith and to sense rotation; and
cleaning the idler with a cleaning mechanism dedicated to cleaning the idler.

20. The method of claim 19 wherein cleaning the idler comprises spraying fluid on the idler via a fluid spray positioned to supply fluid to the idler rather than to the substrate.
